(19) United States
(12) Patent Application Publication
(10) Pub. No.: US 2026/0352777 A1
(43) Pub. Date: Nov. 5, 2026

(54) CONTROL METHOD

(71) Applicant: SEIKO EPSON CORPORATION, Tokyo (JP)

(72) Inventor: Hidehito IISAKA, Shiojiri-shi (JP)

(21) Appl. No.: 19/665,055

(22) Filed: May 1, 2026

(30) Foreign Application Priority Data
May 2, 2025 (JP) 2025-076635

(51) Int. Cl. H04N 5/74; G06V 10/56; G06V 10/60; G06V 10/75

(52) U.S. Cl. CPC H04N 5/74; G06V 10/56; G06V 10/60; G06V 10/758

(57) ABSTRACT

A control method includes: causing, by one processor or a plurality of processors, a projector to project an inspection image onto a projection surface; causing, by the one processor or the plurality of processors, a camera to capture the inspection image projected onto the projection surface to thereby acquire a first captured image including an image corresponding to the inspection image; obtaining, by the one processor or the plurality of processors, a statistic related to a plurality of chromaticities corresponding one-to-one to a plurality of points in the image based on the first captured image; determining, by the one processor or the plurality of processors, whether the statistic exceeds a first threshold value; and notifying, by the one processor or the plurality of processors, an external apparatus of a first notification representing that the statistic exceeds the first threshold value.

The present application is based on, and claims priority from JP Application Serial Number 2025-076635, filed May 2, 2025, the disclosure of which is hereby incorporated by reference herein in its entirety.

### BACKGROUND

### 1. Technical Field

The present disclosure relates to a control method.

### 2. Related Art

JP-A-2016-85349 discloses a projector that executes an image quality confirmation processing of comparing chromaticity of a projection region between a captured image captured earlier and a captured image captured later for each of pixels or each of small regions to thereby determine whether a change in image quality has occurred based on a result of the detection of the pixel or the small region larger in difference of the chromaticity than a predetermined value.

JP-A-2016-85349 is an example of the related art.

However, in the projector according to JP-A-2016-85349, when a projection environment of the projector when the captured image captured later is acquired is different from the projection environment of the projector when the captured image captured earlier is acquired, the image quality confirmation processing cannot be executed.

### SUMMARY

A control method according to an aspect of the present disclosure includes: causing, by one processor or a plurality of processors, a projector to project an inspection image onto a projection surface; causing, by the one processor or the plurality of processors, a camera to capture the inspection image projected onto the projection surface to thereby acquire a first captured image including an image corresponding to the inspection image; obtaining, by the one processor or the plurality of processors, a statistic related to a plurality of chromaticities corresponding one-to-one to a plurality of points in the image based on the first captured image; determining, by the one processor or the plurality of processors, whether the statistic exceeds a first threshold value; and notifying, by the one processor or the plurality of processors, an external apparatus of a first notification representing that the statistic exceeds the first threshold value.

### BRIEF DESCRIPTION OF THE DRAWINGS

FIG. 1 is a block diagram showing an overall configuration of a display system 1.

FIG. 2 is a block diagram illustrating a configuration example of a display apparatus 10.

FIG. 3 is a diagram showing an example of a first inspection image CP1.

FIG. 4 is a diagram showing an example of a second inspection image CP2.

FIG. 5 is a diagram showing an example of a third inspection image CP3.

FIG. 6 is a diagram showing an example of measurement points MP.

FIG. 7 is a diagram illustrating an example of a determination method by a determination unit 140.

FIG. 8 is a diagram illustrating an example of a calculation method by a calculator 139 and the determination method by the determination unit 140.

FIG. 9 is a flowchart showing an operation example of the display apparatus 10.

FIG. 10 is a flowchart showing an operation example of the display apparatus 10.

FIG. 11 is a flowchart showing an operation example of the display apparatus 10.

FIG. 12 is a flowchart showing an operation example of the display apparatus 10.

FIG. 13 is a diagram showing an example of a region CR.

FIG. 14 is a diagram illustrating an example of the calculation method by the calculator 139 and the determination method by the determination unit 140.

### DESCRIPTION OF EMBODIMENTS

Some aspects for implementing the present disclosure will hereinafter be described with reference to the drawings. However, in the drawings, dimensions and scales of the elements are made different from actual ones as appropriate. Further, the embodiments described below are suitable specific examples of the present disclosure, and are therefore attached with technically preferable various limitations, but the scope of the present disclosure is not limited to these embodiments unless there is particularly a description to the effect that the present disclosure is limited in the following explanation.

### 1: First Embodiment

### 1-1: First Embodiment

### 1-1-1: Overall Configuration

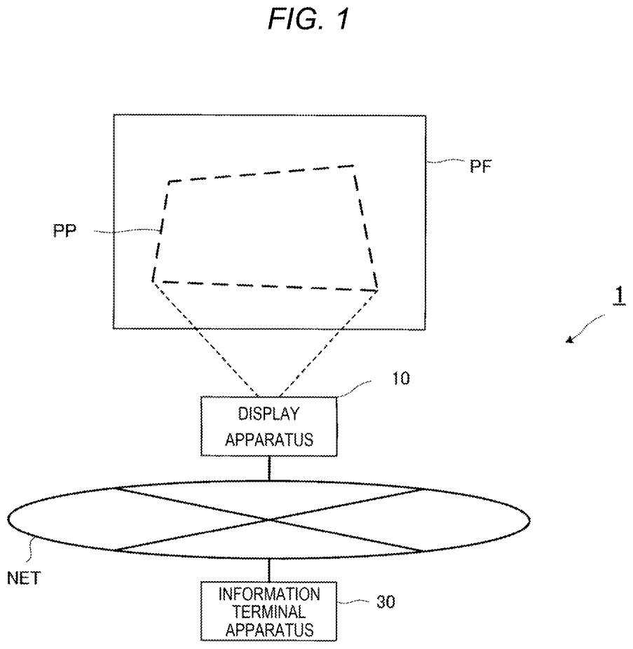

FIG. 1 is a block diagram showing an overall configuration of a display system 1 according to the present embodiment. The display system 1 includes a display apparatus 10 and an information terminal apparatus 30.

In the display system 1 shown in FIG. 1, the display apparatus 10 and the information terminal apparatus 30 are coupled to each other in a communicable manner via a communication network NET.

The display apparatus 10 is, for example, a projection apparatus including a projector 11 described later. The display apparatus 10 projects a projection image PP onto a projection surface PF. The projection surface PF is, for example, a wall or a screen.

The information terminal apparatus 30 is an apparatus that instructs the display apparatus 10 to execute an abnormality detection method described later. The information terminal apparatus 30 is, for example, a personal computer (PC), a tablet, or a smartphone.

### 1-1-2: Configuration of Display Apparatus

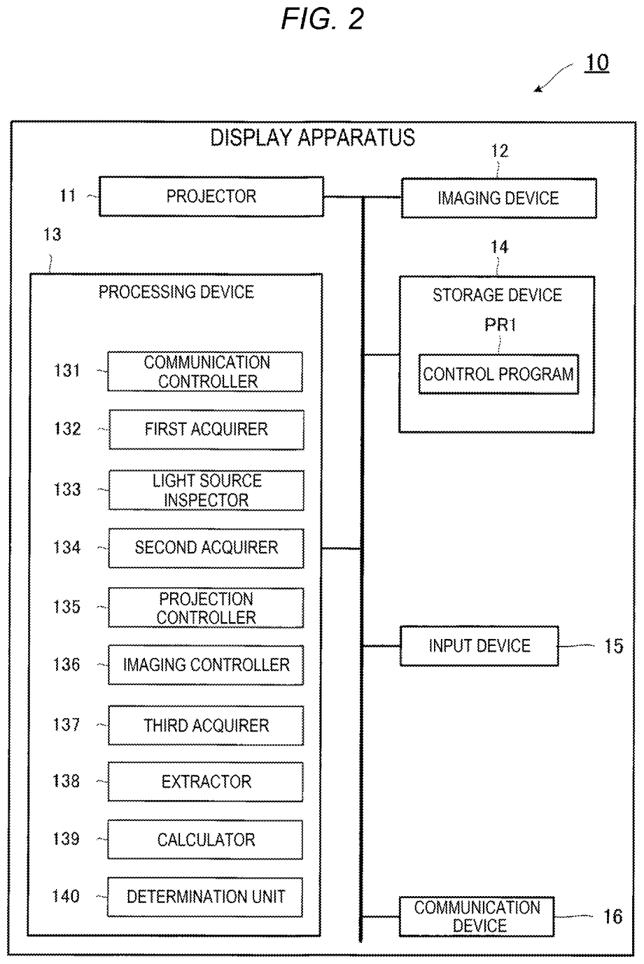

FIG. 2 is a block diagram showing a configuration example of the display apparatus 10. The display apparatus 10 includes the projector 11, an imaging device 12, a processing device 13, a storage device 14, an input device 15, and a communication device 16. Elements of the display apparatus 10 are coupled to each other via a single bus or a plurality of buses for communicating information. The elements of the display apparatus 10 are formed of a single apparatus or a plurality of apparatuses, and some of the elements of the display apparatus 10 may be omitted.

The projector 11 is an apparatus that projects an image acquired by a second acquirer 134 described later onto the projection surface PF. The projector 11 projects various images under the control of the processing device 13. The projector 11 includes, for example, a light source, a light source sensor, a liquid crystal panel, and a projection lens, modulates light from the light source using the liquid crystal panel, and projects the modulated light onto a screen, a wall, or the like via the projection lens. The liquid crystal panel is an example of a light modulation element that generates an image according to input image data. The light modulation element may be a digital mirror device (DMD) instead of the liquid crystal panel. The liquid crystal panel may be of a transmissive type or a reflective type. That is, the type of the light modulation element is the reflective type or the transmissive type.

The imaging device 12 is a device that images an outside world of the display apparatus 10. In the present embodiment, the imaging device 12 images the projection surface PF. The imaging device 12 images the projection surface PF, and as a result, generates a captured image TI in which the projection surface PF is imaged. The imaging device 12 is, for example, a camera incorporated in the display apparatus 10. However, as another example, the imaging device 12 may be an external camera such as a WEB camera.

The processing device 13 is a processor that performs overall control of the display apparatus 10, and is configured with, for example, a single chip or a plurality of chips. The processing device 13 is formed of a central processing unit (CPU) including, for example, an interface with peripheral devices, an arithmetic device, and a register. Note that some or all of the functions of the processing device 13 may be implemented by hardware such as a digital signal processor (DSP), an application specific integrated circuit (ASIC), a programmable logic device (PLD), or a field programmable gate array (FPGA). The processing device 13 executes various types of processing in parallel or in sequence. The processing device 13 is an example of a “computer” that executes a control program PR1. The “computer” is not limited to the processing device 13, and may be an external computing device such as a personal computer or a microcomputer. The storage device 14 is an example of a “storage medium” that stores the control program PR1.

The storage device 14 is a recording medium that the processing device 13 can read and stores a plurality of programs including the control program PR1 to be executed by the processing device 13. The storage device 14 may store the projection image PP to be projected by the display apparatus 10. The “storage medium” is not limited to the storage device 14 incorporated in the processing device 13, and may be an external storage medium existing separately from the processing device 13.

The storage device 14 may be formed of at least one of, for example, a read only memory (ROM), an erasable programmable ROM (EPROM), an electrically erasable programmable ROM (EEPROM), and a random access memory (RAM). The storage device 14 may be called a register, a cache, a main memory, a main storage device, or the like.

The input device 15 is an apparatus that receives an operation from a user of the display apparatus 10. For example, the input device 15 may include a pointing device such as a keyboard, a touch pad, a touch panel, or a mouse. The input device 15 may be incorporated in the display apparatus 10 or may be a remote controller separate from the display apparatus 10.

The communication device 16 is hardware serving as a transmission and reception device for communicating with other apparatuses. The communication device 16 is also called, for example, a network device, a network controller, a network card, or a communication module. The communication device 16 may include a connector for wired connection and an interface circuit corresponding to the connector. The communication device 16 may include a wireless communication interface. Examples of the connector and the interface circuit for wired connection include those compliant with wired LAN, IEEE 1394, and USB. Examples of the wireless communication interface include those compliant with wireless LAN and Bluetooth (registered trademark).

The processing device 13 functions as a communication controller 131, a first acquirer 132, a light source inspector 133, a second acquirer 134, a projection controller 135, an imaging controller 136, a third acquirer 137, an extractor 138, a calculator 139, and a determination unit 140 by reading the control program PR1 from the storage device 14 and then executing the control program PR1. The control program PR1 may be transmitted, via the communication network NET, from another apparatus such as the information terminal apparatus 30 or a server that manages the display apparatus 10.

The communication controller 131 causes the communication device 16 to transmit and receive various types of data, information, and signals to and from other apparatuses. The “other apparatuses” include the information terminal apparatus 30.

As an example, the communication controller 131 causes the communication device 16 to receive various control signals from the information terminal apparatus 30. As another example, the communication controller 131 causes the communication device 16 to receive image data representing the projection image PP from the information terminal apparatus 30.

The first acquirer 132 acquires, from the information terminal apparatus 30, an instruction signal instructing execution of the abnormality detection method by the display apparatus 10.

The light source inspector 133 executes an inspection of the light source provided to the projector 11 when the first acquirer 132 acquires the instruction signal described above.

Specifically, the light source inspector 133 detects an abnormality in the light source based on a difference between a previous detection value and a current detection value output from a light source sensor that detects an amount of light from the light source. The light source sensor is, for example, a photodiode.

More specifically, the light source inspector 133 inspects whether the output from the light source is deteriorated more than expected. The light source inspector 133 inspects the presence or absence of an abnormality in a member such as a phosphor constituting the light source using a color of the light source.

Normally, even when an abnormality occurs in the light source, color unevenness does not occur in the projection image PP displayed on the projection surface PF.

The second acquirer 134 acquires the projection image PP from the storage device 14. In the present embodiment, in order to inspect the abnormality in the image quality of the image displayed on the projection surface PF by the display apparatus 10, the second acquirer 134 acquires an inspection image CP from the storage device 14 as the projection image PP.

In the present embodiment, in order to inspect the abnormality in the image quality of the image on the projection surface PF, a color difference in a plane of the image on the projection surface PF is used as an index of the image quality.

The user of the display apparatus 10 is usually hard to be aware of a temporal change in tint of the entire projection surface PF, but is easily aware of the color difference in the plane of the image on the projection surface PF. By using the color difference in the plane of the image on the projection surface PF as the index of the image quality, the display apparatus 10 can execute the determination of the abnormality in the image quality close to an impression of a human who views the image.

Further, the abnormality in the image quality on the projection surface PF is often caused by adhesion of dust to a projection lens provided to the display apparatus 10 or deterioration locally occurring in a liquid crystal panel, a wave plate, a polarization plate, or the like. By the display apparatus 10 using the color difference in the projection surface PF as the index of the image quality, the detected abnormality is easily associated with the cause of the occurrence of the abnormality. Note that an abnormality occurring in the liquid crystal panel, the wave plate, the polarization plate, or the like is relatively more likely to appear in the color difference than an abnormality occurring in the projection lens.

In addition, the display apparatus 10 can cancel external factors such as a difference in color of the projection surface PF and an illumination state during imaging described later by using the color difference in the projection surface PF as the index of the image quality. As a result, the method of detecting an abnormality in image quality according to the present embodiment has high environmental robustness.

In addition, since the result of the previous inspection is not essential, an abnormality can be detected with a single inspection.

Therefore, the display apparatus 10 is required to use an image for obtaining a color distribution in the plane of the projection surface PF as the inspection image CP.

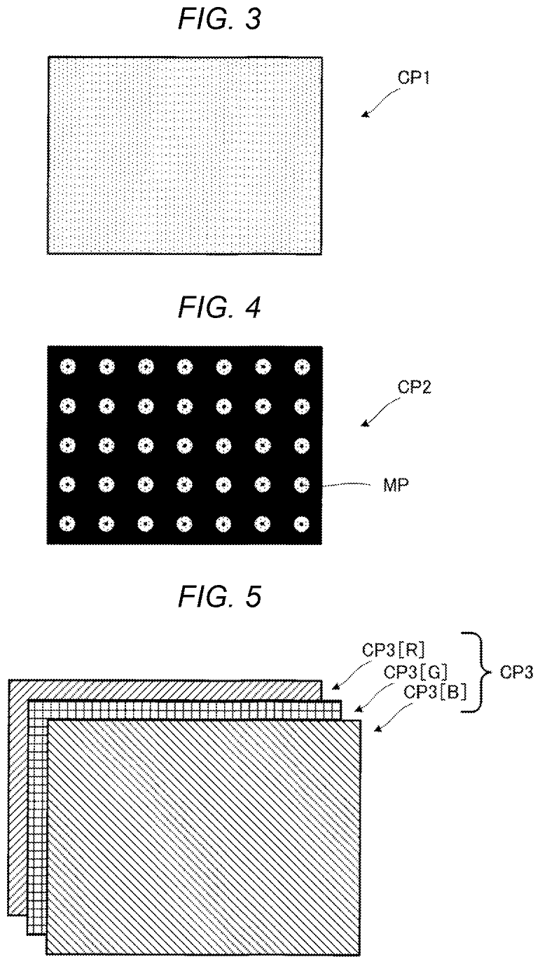

FIG. 3 is a diagram illustrating an example of a first inspection image CP1. The first inspection image CP1 is an achromatic halftone image. The first inspection image CP1 is an achromatic image to which a human is highly sensitive.

The first inspection image CP1 preferably has a gray level in which the brightness of the projection surface PF is no smaller than five times of the brightness of the installation environment of the display apparatus 10 at least at the timing when the inspection image CP is captured. Specifically, it is sufficient that the brightness of the projection surface PF in a state in which the inspection image CP is projected on the projection surface PF from the display apparatus 10 is no smaller than five times as high as the brightness of the projection surface PF in a state in which the inspection image CP is not projected on the projection surface PF from the display apparatus 10. As a result, the display apparatus 10 can suppress the influence of the installation environment of the display apparatus 10.

Further, it is preferable for the first inspection image CP1 to have a gray level no higher than 70% with respect to a maximum brightness of the projector 11. As a result, the display apparatus 10 easily detects an abnormality occurring in the liquid crystal panel, the wave plate, the polarization plate, or the like of the projector 11.

FIG. 4 is a diagram illustrating an example of a second inspection image CP2. The second inspection image CP2 includes measurement points MP in a 5×7 matrix. As will be described later, the captured image TI is generated by projecting the second inspection image CP2 on the projection surface PF, and then capturing the second inspection image CP2 projected on the projection surface PF by the imaging device 12. The measurement points MP described above are each a point serving as the measurement point MP in an image CI corresponding to the second inspection image CP2 in the captured image TI.

In the second inspection image CP2, a predetermined range centered on the measurement point MP described later has substantially the same gray level as that of the first inspection image CP1. Meanwhile, in the second inspection image CP2, a portion other than that predetermined range is black.

As a result, the second inspection image CP2 can suppress the influence of the installation environment of the display apparatus 10, similarly to the first inspection image CP1. Further, the display apparatus 10 can easily extract the measurement points MP by using the second inspection image CP2.

Note that the second inspection image CP2 illustrated in FIG. 4 includes the measurement points MP in the 5×7 matrix, but this is illustrative only. For example, when the aspect ratio of the second inspection image CP2 is 19:6, it is preferable for the display apparatus 10 to divide the second inspection image CP2 into regions in a 6×19 matrix and set the center points of the regions as the measurement points MP. In this case, the second inspection image CP2 includes the measurement points MP in the 6×19 matrix.

FIG. 5 is a diagram illustrating an example of a third inspection image CP3. The third inspection image CP3 includes, as three inspection images CP, an inspection image CP3[R], an inspection image CP3[G], and an inspection image CP3[B]. The inspection image CP3[R] is a monochromatic image of the R color. The inspection image CP3[G] is a monochromatic image of the G color. The inspection image CP3[B] is a monochromatic image of the B color. The gray level of each of the inspection images CP3 is substantially the same as the gray level of the first inspection image CP1.

The projection controller 135 described later causes the projector 11 to individually project the inspection image CP3[R], the inspection image CP3[G], and the inspection image CP3[B] onto the projection surface PF. The imaging controller 136 described later causes the imaging device 12 to individually capture the inspection image CP3[R], the inspection image CP3[G], and the inspection image CP3[B] projected on the projection surface PF. The extractor 138 and the calculator 139 described later can obtain achromatic color data by calculation using all the capturing results of the inspection image CP3[R], the inspection image CP3[G], and the inspection image CP3[B].

The display apparatus 10 can easily obtain accurate chromaticity by individually using the inspection image CP3[R], the inspection image CP3[G], and the inspection image CP3[B] and combining these with the wavelength sensitivity of the imaging device 12. In addition, by using the third inspection image CP3, it becomes easy for the display apparatus 10 to identify which liquid crystal panel has an abnormality out of the three liquid crystal panels corresponding one-to-one to R, G, and B colors, and to analyze the factors of the abnormality in image quality.

Going back to FIG. 2, the projection controller 135 causes the projector 11 to project, onto the projection surface PF, the inspection image CP acquired by the second acquirer 134.

The imaging controller 136 causes the imaging device 12 to image the projection surface PF on which the inspection image CP is projected to generate the captured image TI. The captured image TI includes the image CI corresponding to the inspection image CP. The captured image TI is an example of a “first captured image”.

The third acquirer 137 acquires the captured image TI that the imaging controller 136 has caused the imaging device 12 to generate.

The extractor 138 extracts a plurality of measurement points MP of the image CI corresponding to the inspection image CP contained in the captured image TI. The plurality of measurement points MP is an example of a “plurality of points”.

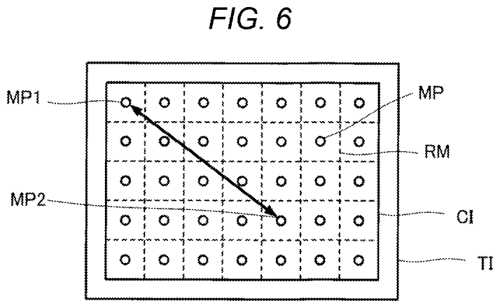

FIG. 6 is a diagram illustrating an example of the measurement points MP. As illustrated in FIG. 6, as an example, the extractor 138 divides the image CI into a plurality of regions RM arranged in a 5×7 matrix, and extracts the center point of each of the regions RM as the measurement point MP.

Note that the image CI illustrated in FIG. 6 is divided into the regions RM arranged in the 5×7 matrix, but this is illustrative only. For example, when the aspect ratio of the image CI is 19:6, it is preferable for the display apparatus 10 to divide the image CI into regions arranged in a 6×19 matrix, and set the center points of the regions as the measurement points MP. In this case, the image CI includes the measurement points MP arranged in the 6×19 matrix.

Going back to FIG. 2, the calculator 139 calculates a plurality of color coordinates corresponding one-to-one to the plurality of measurement points MP in the image CI based on RGB values of the captured image TI. The color coordinate is, for example, a uniform chromaticity. A known method is used for conversion from an RGB value to a uniform chromaticity.

As an example, the calculator 139 calculates an average value of the chromaticities of the respective pixels belonging to the whole of each of the regions RM as the chromaticity at the measurement point MP belonging to that region RM. In this case, the display apparatus 10 easily copes with a change in the entire image CI.

In addition, as another example, in each of the regions RM, the calculator 139 calculates an average chromaticity in a predetermined region in the vicinity of the measurement point MP as the chromaticity at that measurement point MP. The predetermined region is, for example, a region of 10×10 pixels including the measurement point MP. In this case, the display apparatus 10 can suppress the calculation load.

It is preferable for the calculator 139 to determine which one of the values described above is set as the chromaticity at the measurement point MP in accordance with the resource allowed for extraction or the number of divisions of the image CI.

When calculating the chromaticity of each of the pixels belonging to the image CI or the chromaticity of the measurement point MP, the calculator 139 preferably executes calibration processing. Specifically, it is preferable for the calculator 139 to subtract the RGB value of each of the pixels belonging to the captured image TI obtained by imaging the projection surface PF on which the inspection image CP is not projected from the RGB value of each of the pixels belonging to the captured image TI obtained by imaging the projection surface PF on which the inspection image CP is projected, and calculate the color coordinates using the result. The “captured image TI obtained by imaging the projection surface PF on which the inspection image CP is projected” is an example of a “first captured image”. The “captured image TI obtained by imaging the projection surface PF on which the inspection image CP is not projected” is an example of a “sixth captured image”. In addition, in this case, the RGB value of the pixel at a first position, that is, a first measurement point MP1 in the captured image TI as the sixth captured image is subtracted from the chromaticity of the pixel at the first position, that is, the first measurement point MP1 in the captured image TI as the first captured image. Here, the first measurement point MP1 in the captured image TI as the sixth captured image is an example of one of a “plurality of second points”. That is, the subtraction of the RGB values is performed on the chromaticities of the same measurement point MP in the first captured image and the sixth captured image.

As a result, it is possible to reduce the influence of the installation environment of the display apparatus 10 in the abnormality determination processing by the display apparatus 10. The display apparatus 10 can further reduce that influence in particular when the imaging environment is bright.

Further, the calculator 139 obtains statistics regarding a plurality of chromaticities corresponding one-to-one to the plurality of measurement points MP using the chromaticities of the plurality of measurement points MP.

As an example, the statistic is a maximum value of a difference in chromaticity at the plurality of measurement points MP. In FIG. 6, as an example, when the color coordinate at the first measurement point MP1 is (u1′, v1′) and the color coordinate at a second measurement point MP2 is (u2′, v2′), the calculator 139 calculates a difference Δu′v′ in chromaticity between the first measurement point MP1 and the second measurement point MP2, that is, a color difference by the following formula 1.

Δu′v′=\sqrt{(u1′−u2′)²+(v1′−v2′)²} (1)

The calculator 139 calculates Δu′v′ in a round-robin manner for a combination of two measurement points MP out of all the measurement points MP, and sets a maximum value Δu′v′ₘₐₓ thereof as the statistic described above.

When the calculator 139 uses the maximum value Δu′v′ₘₐₓ of the difference in chromaticity at the plurality of measurement points MP as the statistic described above, the detection sensitivity of the abnormality locally occurring on the projection surface PF increases. The display apparatus 10 can cancel the influence of the projection surface PF and the illumination environment in the abnormality determination processing.

As another example, the statistic is a variance value S of the chromaticities at the plurality of measurement points MP. When the color coordinate of each of the measurement points MP is (u′, v′) and an average value of the color coordinates of all the measurement points MP is (au′, av′), the calculator 139 calculates the variance value S by the following formula 2 and sets the variance value S as the statistic described above.

S={square root over (Σ((u′−a u′)²+(v′−a v′)²)/(n−1))} (2)

When the calculator 139 uses the variance value S of the chromaticity at the plurality of measurement points MP as the statistic described above, the detection accuracy of the abnormality caused by a specific factor such as adhesion of dust to an optical component is increased, and it becomes easy to detect an abnormality in the entire projection surface PF. The display apparatus 10 can cancel the influence of the projection surface PF itself and the illumination environment in the abnormality determination processing.

Going back to FIG. 2, the determination unit 140 determines whether the statistic obtained by the calculator 139 exceeds a threshold value th1. The threshold value th1 is an example of a “first threshold value”.

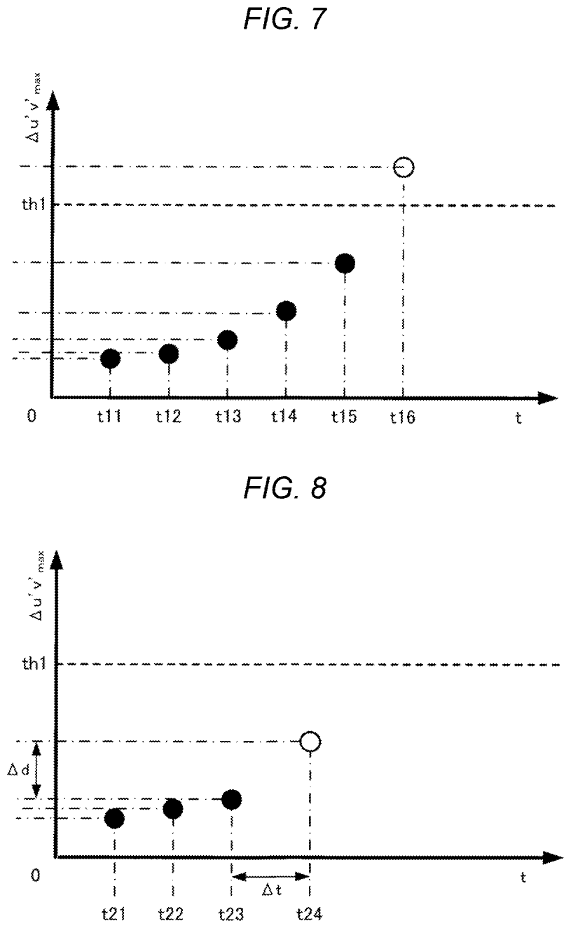

FIG. 7 is a diagram illustrating an example of a determination method by the determination unit 140. The determination unit 140 determines that the maximum value Δu′v′ₘₐₓ of the difference in chromaticity is less than the threshold value th1 in a period from time t=t11 to time t=t15. Meanwhile, at time t=t16, the determination unit 140 determines that the maximum value Δu′v′ₘₐₓ of the difference in chromaticity exceeds the threshold value th1. When an abnormality occurs in the liquid crystal panel, the wave plate, the polarization plate, or the like, the chromaticity value tends to increase compared to the chromaticity value before the abnormality occurs. Examples of the factor of the above include the fact that an abnormality occurs in an electrode of the pixel of the liquid crystal panel, and thus, a voltage lower than a rated voltage is applied to the pixel, and it becomes unachievable to exert an original shutter function. Thus, even when the rated voltage is applied to the entire liquid crystal panel, the transmittance of some pixels in which the abnormality has occurred does not change while the transmittance of the normal pixels changes, which incurs non-uniformity of Δu′v′, and as a result, a phenomenon in which Δu′v′ₘₐₓ exceeds the threshold value th1 occurs.

Note that FIG. 7 illustrates when the statistic calculated by the calculator 139 is the maximum value Δu′v′ₘₐₓ of the difference in chromaticity. However, the same applies when that statistic is the variance value S. When that statistic is the variance value S, an appropriate value according to the variance value S is set as the threshold value th1.

Going back to FIG. 2, when the determination unit 140 determines that the statistic obtained by the calculator 139 exceeds the threshold value th1, the communication controller 131 notifies the information terminal apparatus 30 as an external apparatus of the fact that the statistic exceeds the threshold value th1 as a first notification. The first notification is also a notification of an occurrence of an abnormality in image quality on the projection surface PF.

Note that the display apparatus 10 can preliminarily predict the occurrence of an abnormality in an anterior stage of the detection of the abnormality in the image quality on the projection surface PF described above. Specifically, the display apparatus 10 can preliminarily predict the occurrence of the abnormality when a change rate of the statistic calculated this time compared to the statistic calculated last time exceeds a threshold value. The fact that the change rate exceeds the threshold value corresponds to, for example, when the deterioration of the display apparatus 10 rapidly progresses due to, for example, an increase in density of dust in the installation environment of the display apparatus 10 although an abnormality itself does not occur in the display apparatus 10.

In this case, specific processing contents of the processing device 13 are as follows.

At a first time point, the projection controller 135 causes the projector 11 to project the inspection image CP onto the projection surface PF. The imaging controller 136 causes the imaging device 12 to image the projection surface PF on which the inspection image CP is projected to generate the captured image TI. The captured image TI is an example of a “second captured image”. The calculator 139 obtains statistics related to a plurality of chromaticities corresponding one-to-one to the plurality of measurement points MP based on the captured image TI. The statistic is an example of a “first statistic”.

At a second time point subsequent to the first time point, the projection controller 135 causes the projector 11 to project the inspection image CP onto the projection surface PF. The imaging controller 136 causes the imaging device 12 to image the projection surface PF on which the inspection image CP is projected to generate the captured image TI. The captured image TI is an example of a “third captured image”. The calculator 139 obtains statistics related to a plurality of chromaticities corresponding one-to-one to the plurality of measurement points MP based on the captured image TI. The statistic is an example of a “second statistic”.

Further, the calculator 139 calculates a change rate from the first statistic to the second statistic.

The determination unit 140 determines whether the change rate from the first statistic to the second statistic exceeds a threshold value th2. The change rate is an example of a “first change rate”. The threshold value th2 is an example of a “second threshold value”.

FIG. 8 is a diagram illustrating an example of a calculation method by the calculator 139 and a determination method by the determination unit 140. The calculator 139 calculates the change rate described above by dividing a difference Δd between the maximum value Δu′v′ₘₐₓ of the difference in chromaticity calculated last time and the maximum value Δu′v′ₘₐₓ of the difference in chromaticity calculated this time by a difference Δt between the time point when the maximum value is calculated last time and the time point when the maximum value is calculated this time. In the example illustrated in FIG. 8, the determination unit 140 determines that the change rate is lower than the threshold value th2 in a period from time t=t21 to time t=t23. Meanwhile, the determination unit 140 determines that the change rate exceeds the threshold value th2 at time t=t24. Note that in a period from the time t=t21 to the time t=t24, the maximum value Δu′v′ₘₐₓ of the difference in chromaticity has not yet exceeded the threshold value th1. That is, the determination unit 140 determines that the change rate exceeds the threshold value th2 in an anterior stage of the detection of the abnormality in the image quality on the projection surface PF.

Going back to FIG. 2, when the determination unit 140 determines that the change rate obtained by the calculator 139 exceeds the threshold value th2, the communication controller 131 notifies the information terminal apparatus 30 as an external apparatus of the fact that the change rate exceeds the threshold value th2 as a second notification. The second notification is also a notification that the abnormality in the image quality on the projection surface PF is preliminarily predicted.

In recent years, a display apparatus that projects the projection image PP is often installed permanently and is used in a large-scale facility such as an event venue. Therefore, a device that monitors the state of the display apparatus to detect an abnormality has previously been studied. In the case described above, even when an abnormality occurs, the display apparatus cannot be maintained immediately in many cases on the various grounds such that the installation place of the display apparatus is a high place, or that the display apparatus is permanently used. Therefore, there is a strong demand for the device that detects the abnormality before a problem occurs in the use of the display apparatus. Note that examples of the cause of the abnormality include adhesion of dust to optical members, and those caused by the installation environment of the display apparatus such as a high-temperature and high-humidity environment in addition to general aging deterioration of the display apparatus.

In addition, since there are various installation environments of the display apparatus and it is conceivable that the environment may change by imaging with the imaging device, a method high in robustness with respect to the environment is required as the method of detecting the abnormality.

However, in the related art, for example, even when only the installation environment of the display apparatus such as the state of the projection surface PF or the illumination condition changes, it is often determined that an abnormality has occurred in the display apparatus, and the robustness to the environment is low.

Further, in the related art, the abnormality in the image quality subjectively considered by the user of the display apparatus does not match the abnormality in the image quality actually detected. For example, in the related art, when the degree of the color in the plane of the projection surface PF does not change but the distribution of the color changes, it is determined to be abnormal. In addition, even when a large color difference is locally generated in the plane of the projection surface PF, it is not determined to be abnormal in the related art as long as the area of the color difference is small, however, on the other hand, the user of the display apparatus subjectively determines that it is abnormal.

Regarding these points, the method of determining an abnormality in the image quality according to the present embodiment is high in robustness to the environment as described above. In addition, in the method of determining an abnormality in the image quality according to the present embodiment, the degree of coincidence between an abnormality in image quality subjectively considered by the user of the display apparatus 10 and an abnormality in image quality actually detected is higher than in the related art.

### 1-2: Operation of First Embodiment

### 1-2-1: First Operation Example

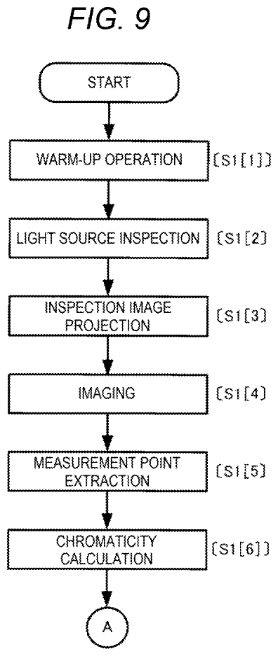

FIGS. 9 to 12 are flowcharts illustrating operation examples of the display apparatus 10.

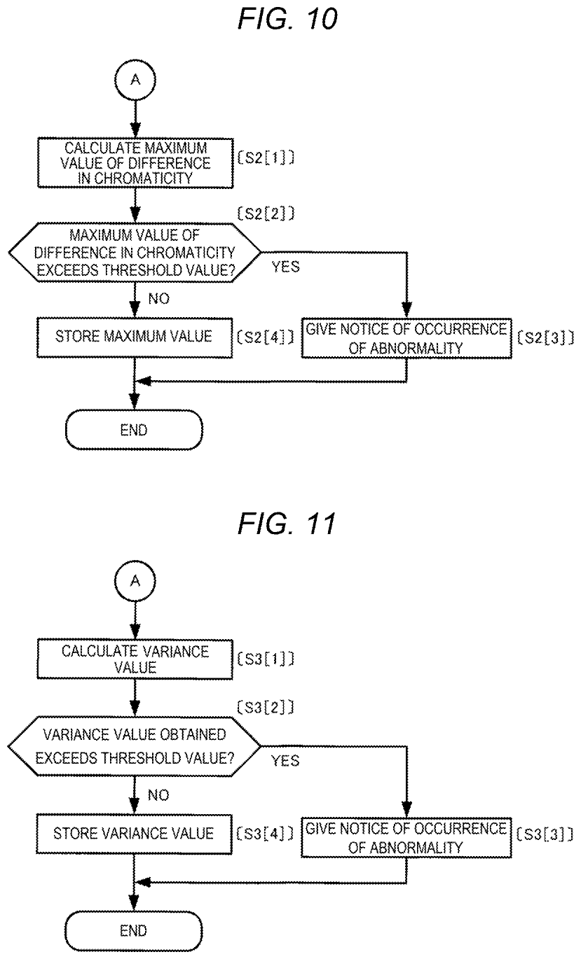

First, a first operation example of the display apparatus 10 will be described with reference to FIGS. 9 and 10. The first operation example is an operation of executing steps S1[1] to S1[6] shown in FIG. 9, and then executing steps S2[1] to S2[4] shown in FIG. 10.

In step S1[1], the display apparatus 10 performs a warm-up operation for a certain period of time until an internal temperature of the projector 11 is stabilized in order to equalize the temperature states of the respective members constituting the display apparatus 10. The certain time is, for example, 5 minutes to 30 minutes.

In step S1[2], the processing device 13 provided to the display apparatus 10 functions as the light source inspector 133. The processing device 13 detects an abnormality in the light source based on a difference between a previous detection value and a current detection value using the light source sensor that detects an amount of the light from the light source.

In step S1[3], the processing device 13 functions as the projection controller 135. The processing device 13 causes the projector 11 to project the in https://claude.ai/chat/ce02a04d-4511-416b-a2a0-f685f1f1c7despection image CP acquired from the storage device 14 onto the projection surface PF.

In step S1[4], the processing device 13 functions as the imaging controller 136. The processing device 13 causes the imaging device 12 to image the projection surface PF on which the inspection image CP is projected to thereby generate the captured image TI.

In step S1[5], the processing device 13 functions as the extractor 138. The processing device 13 extracts a plurality of measurement points MP of the image CI. The image CI corresponds to the inspection image CP contained in the captured image TI acquired from the imaging device 12.

In step S1[6], the processing device 13 functions as the calculator 139. The processing device 13 calculates a plurality of chromaticities corresponding one-to-one to the plurality of measurement points MP in the plane of the image CI based on the captured image TI.

In step S2[1], the processing device 13 functions as the calculator 139. The processing device 13 calculates the maximum value Δu′v′ₘₐₓ of the difference in chromaticity at the plurality of measurement points MP.

In step S2[2], the processing device 13 functions as the determination unit 140. The processing device 13 determines whether the maximum value Δu′v′ₘₐₓ of the difference in chromaticity calculated in step S2[1] exceeds the threshold value th1. When the maximum value Δu′v′ₘₐₓ of the difference in chromaticity exceeds the threshold value th1, the processing device 13 executes the processing in step S2[3]. When the maximum value Δu′v′ₘₐₓ of the difference in chromaticity does not exceed the threshold value th1, the processing device 13 executes the processing in step S2[4].

In step S2[3], the processing device 13 functions as the communication controller 131. The processing device 13 notifies the information terminal apparatus 30 as an external apparatus of the fact that the maximum value Δu′v′ₘₐₓ of the difference in chromaticity exceeds the threshold value th1 as the first notification for giving a notice of the occurrence of the abnormality in the image quality on the projection surface PF.

In step S2[4], the processing device 13 stores, in the storage device 14, the maximum value Δu′v′ₘₐₓ of the difference in chromaticity calculated in step S2[1].

### 1-2-2: Second Operation Example

A second operation example of the display apparatus 10 will be described with reference to FIGS. 9 and 11. The second operation example is an operation of executing steps S1[1] to S1[6] shown in FIG. 9, and then executing steps S3[1] to S3[4] shown in FIG. 11. Note that, since steps S1[1] to S1[6] are the same as steps S1[1] to S1[6] in the first operation example, the description thereof will be omitted.

In step S3[1], the processing device 13 functions as the calculator 139. The processing device 13 calculates the variance value S of the chromaticities at the plurality of measurement points MP.

In step S3[2], the processing device 13 functions as the determination unit 140. The processing device 13 determines whether the variance value S of the chromaticities calculated in step S3[1] exceeds the threshold value th1. When the variance value S of the chromaticities exceeds the threshold value th1, the processing device 13 executes the processing in step S3[3]. When the variance value S of the chromaticities does not exceed the threshold value th1, the processing device 13 executes the processing in step S3[4].

In step S3[3], the processing device 13 functions as the communication controller 131. The processing device 13 notifies the information terminal apparatus 30 as an external apparatus of the fact that the variance value S of the chromaticities exceeds the threshold value th1 as the first notification for giving a notice of the occurrence of the abnormality in the image quality on the projection surface PF.

In step S3[4], the processing device 13 stores, in the storage device 14, the variance value S of the chromaticities calculated in step S3[1].

### 1-2-3: Third Operation Example

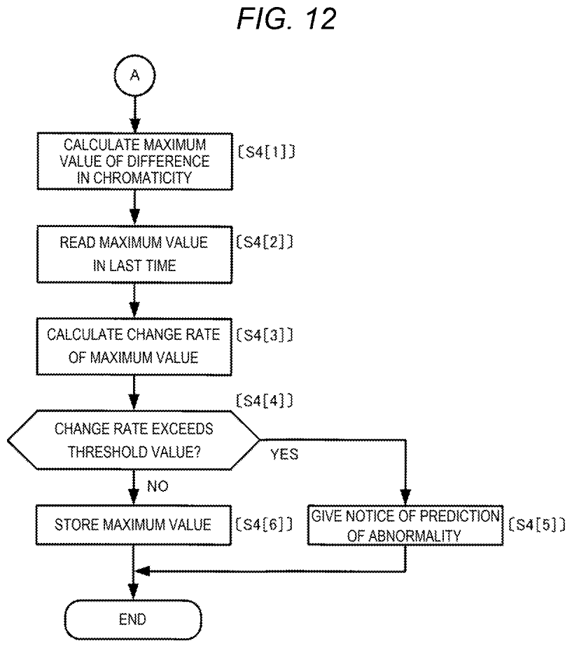

A third operation example of the display apparatus 10 will be described with reference to FIGS. 9 and 12. The third operation example is an operation of executing steps S1[1] to S1[6] shown in FIG. 9, and then executing steps S4[1] to S4[6] shown in FIG. 12. Note that, since steps S1[1] to S1[6] are the same as steps S1[1] to S1[6] in the first operation example, the description thereof will be omitted.

In step S4[1], the processing device 13 functions as the calculator 139. The processing device 13 calculates the maximum value Δu′v′ₘₐₓ of the difference in chromaticity at the plurality of measurement points MP.

In step S4[2], the processing device 13 functions as the calculator 139. The processing device 13 reads the maximum value Δu′v′ₘₐₓ of the difference in chromaticity at the plurality of measurement points MP which is calculated last time and is stored in the storage device 14.

In step S4[3], the processing device 13 functions as the calculator 139. The processing device 13 calculates the change rate of the maximum value Δu′v′ₘₐₓ of the difference in chromaticity by dividing the difference Δd between the maximum value Δu′v′ₘₐₓ of the difference in chromaticity calculated last time and the maximum value Δu′v′ₘₐₓ of the difference in chromaticity calculated this time by the difference Δt between the time point when the maximum value is calculated last time and the time point when the maximum value is calculated this time.

In step S4[4], the processing device 13 functions as the determination unit 140. The processing device 13 determines whether the change rate calculated in step S4[3] exceeds the threshold value th2. When the change rate exceeds the threshold value th2, the processing device 13 executes the processing in step S4[5]. When the change rate does not exceed the threshold value th2, the processing device 13 executes the processing in step S4[6].

In step S4[5], the processing device 13 functions as the communication controller 131. The processing device 13 notifies, as the second notification, the information terminal apparatus 30 as an external apparatus of the fact that the change rate calculated in step S4[3] exceeds the threshold value th2. The second notification is for giving a notice that the abnormality in the image quality on the projection surface PF has been preliminarily predicted.

In step S4[6], the processing device 13 stores, in the storage device 14, the maximum value Δu′v′ₘₐₓ of the difference in chromaticity calculated in step S4[1].

### 2: Modified Examples

The embodiment described above can variously be modified. Specific aspects of the modifications will be exemplified below. The aspects exemplified below and the aspects described in the above embodiment can be combined as appropriate within a range where no mutual contradiction is involved. Note that, in the modification examples exemplified below, elements having actions and functions equivalent to those in the embodiment are denoted by the reference numerals and signs referred to in the above explanation and detailed explanation of the elements is omitted as appropriate.

### 2-1: Modified Example 1

In the display apparatus 10 according to the embodiment described above, the processing device 13 executes the series of processing described above of detecting an abnormality in the quality of the image displayed on the projection surface PF when the first acquirer 132 acquires, from the information terminal apparatus 30, the instruction signal for instructing execution of the abnormality detection method by the display apparatus 10.

However, the processing device 13 may execute the series of processing described above of detecting an abnormality in the quality of the image displayed on the projection surface PF in response to another event.

For example, the processing device 13 may execute the series of processing described above at a date and time designated in advance based on a date and time measured by a clock installed in the display apparatus 10.

Alternatively, the processing device 13 may execute the series of processing described above based on the content of input by the user of the display apparatus 10 using the input device 15.

Alternatively, the processing device 13 may execute the series of processing described above based on an instruction via the communication network NET. As an example, the instruction may be an instruction from management software installed in a terminal apparatus connected to the communication network NET.

### 2-2: Modified Example 2

The display apparatus 10 according to the embodiment described above detects the abnormality in the quality of the image displayed on the projection surface PF based on the color unevenness or the change in chromaticity in the plane of the image CI. The abnormality is assumed to be a problem that occurs inside the display apparatus 10.

As another problem, for example, there is a problem that the brightness is uniformly reduced in the plane of the image CI without the color unevenness or the change in chromaticity in the plane due to adhesion of dust to the projection lens.

Therefore, the display apparatus 10 according to the present modified example detects an abnormality in the quality of the image displayed on the projection surface PF based on the change in brightness in the plane of the image CI.

In this case, specific processing contents of the processing device 13 are as follows.

At a third time point, the projection controller 135 causes the projector 11 to project the inspection image CP onto the projection surface PF. The imaging controller 136 causes the imaging device 12 to image the projection surface PF on which the inspection image CP is projected to generate the captured image TI. The captured image TI is an example of a “fourth captured image”. The calculator 139 obtains statistics related to a plurality of brightness values corresponding one-to-one to the plurality of measurement points MP based on the captured image TI. The statistic is an example of a “third statistic”. The brightness value as the “third statistic” is an example of a “first brightness value”.

At a fourth time point subsequent to the third time point, the projection controller 135 causes the projector 11 to project the inspection image CP onto the projection surface PF. The imaging controller 136 causes the imaging device 12 to image the projection surface PF on which the inspection image CP is projected to generate the captured image TI. The captured image TI is an example of a “fifth captured image”. The calculator 139 obtains statistics related to a plurality of brightness values corresponding one-to-one to the plurality of measurement points MP based on the captured image TI. The statistic is an example of a “fourth statistic”. The brightness value as the “fourth statistic” is an example of a “second brightness value”.

The calculation method of the “first brightness value” as the “third statistic” and the “second brightness value” as the “fourth statistic” by the calculator 139 is as follows.

The calculator 139 calculates a Y value, which is a brightness value of each of the pixels contained in the image CI, based on the RGB values (an R value, a G value, and a B value), which are the pixel values of each of the pixels contained in the captured image TI, and exposure information (specifically, an exposure time, a gain, and an aperture) used in imaging. Specifically, the calculator 139 converts the R value, the G value, and the B value of each of the pixels contained in the image CI into values under the same exposure condition using a formula 3 described below. In the formula 3 described below, A represents any one of the R value, the G value, and the B value.

$${A}^{′} = \frac{A}{x} \qquad ( 3 )$$

Further, the calculator 139 obtains a relationship between an aperture value and an amount of light incident on an image sensor in advance, and processes the R value, the G value, and the B value having been converted using the relationship so as to be values when setting the same aperture value at the third time point and the fourth time point described above.

Note that the calculator 139 may process the R value, the G value, and the B value of each of the pixels contained in the image CI using the relationship between the aperture value and the amount of light incident on the image sensor so as to be the values when setting the same aperture value at the third time point and the fourth time point, and then convert the values into values under the same exposure condition using the formula 3 described above.

After the conversion using the formula 3 described above, the calculator 139 calculates the Y value, which is the brightness value of each of the pixels, using the R value, the G value, and the B value processed so as to be the values when setting the same aperture value. As an example, the calculator 139 may calculate the Y value using a formula 4 described below.

Y=0.2126R+0.7152G+0.0722B (Formula 4)

Further, the calculator 139 calculates an average value of the Y values in a region CR including a preset proportion of pixels to the total number of pixels of the image CI in the vicinity of the center of the image CI in the image CI.

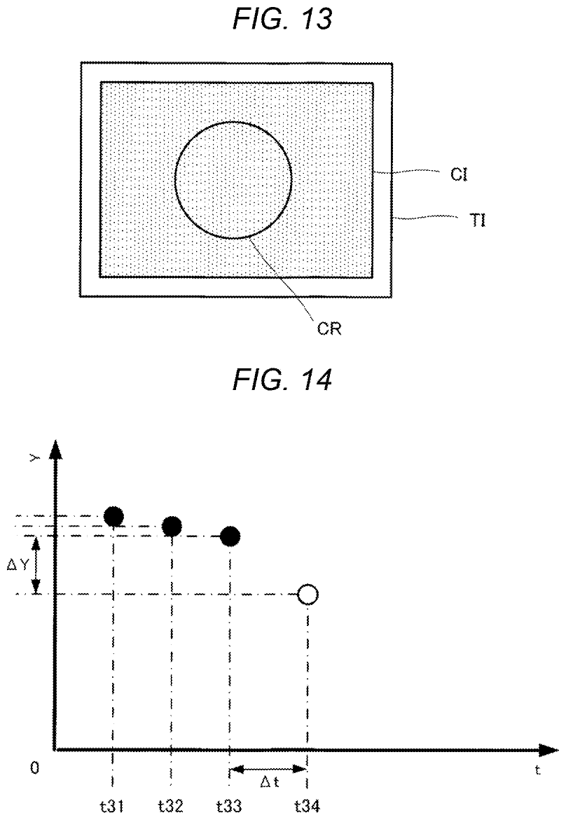

FIG. 13 is a diagram illustrating an example of the region CR. As illustrated in FIG. 13, it is preferable for the region CR to be a central portion of the image CI and to be a region including 30% of the total number of pixels of the image CI.

The calculator 139 may use the G value instead of the Y value for the sake of convenience.

Further, the calculator 139 calculates a change rate from the third statistic to the fourth statistic. In other words, the calculator 139 calculates the change rate from the first brightness value to the second brightness value.

The determination unit 140 determines whether the change rate from the first brightness value to the second brightness value exceeds a threshold value th3. The change rate is an example of a “second change rate”. The threshold value th3 is an example of a “third threshold value”.

FIG. 14 is a diagram illustrating an example of a calculation method by the calculator 139 and a determination method by the determination unit 140. The calculator 139 calculates the change rate described above by dividing a difference ΔY between an average value of the Y values calculated last time and an average value of the Y values calculated this time by the difference Δt between the time point when the average value is calculated last time and the time point when the average value is calculated this time. In the example illustrated in FIG. 14, the determination unit 140 determines that the change rate is lower than the threshold value th3 in a period from time t=t31 to time t=t33. Meanwhile, the determination unit 140 determines that the change rate exceeds the threshold value th3 at time t=t34.

When the determination unit 140 determines that the change rate obtained by the calculator 139 exceeds the threshold value th3, the communication controller 131 notifies the information terminal apparatus 30 as an external apparatus of the fact that the change rate exceeds the threshold value th3 as a third notification. The third notification is also a notification of an abnormality in the display on the projection surface PF.

Also in the present modification, similarly to the embodiment described above, it is preferable for the calculator 139 to execute calibration processing when calculating the brightness of each of the pixels contained in the image CI. Specifically, it is preferable for the calculator 139 to subtract the RGB values of each of the pixels contained in the captured image TI obtained by imaging the projection surface PF on which no image is projected from the RGB values of each of the pixels contained in the captured image TI obtained by imaging the projection surface PF on which the inspection image CP is projected.

The third time point may be the same as or different from the first time point. Similarly, the fourth time point may be the same as or different from the second time point.

### 3: Summary of Present Disclosure

The present disclosure will be summarized below as appendices.

(Appendix 1) A control method including: causing, by one processor or a plurality of processors, a projector to project an inspection image onto a projection surface; causing, by the one processor or the plurality of processors, a camera to capture the inspection image projected onto the projection surface to thereby acquire a first captured image including an image corresponding to the inspection image; obtaining, by the one processor or the plurality of processors, a statistic related to a plurality of chromaticities corresponding one-to-one to a plurality of points in the image based on the first captured image; determining, by the one processor or the plurality of processors, whether the statistic exceeds a first threshold value; and notifying, by the one processor or the plurality of processors, an external apparatus of a first notification representing that the statistic exceeds the first threshold value.

According to the configuration described above, determination of an abnormality high in robustness to the environment becomes possible. According to the configuration described above, determination of an abnormality close to the subjective view of the user of the display apparatus 10 becomes possible. Further, according to the configuration described above, it is possible to suppress a decrease in determination accuracy of the image quality compared to when comparing a captured image captured earlier with a captured image captured later. Further, according to the configuration described above, the user of the display apparatus 10 can remotely recognize the abnormality in the image quality of the display apparatus 10. The user of the display apparatus 10 can avoid the occurrence of a problem in the use of the display apparatus 10 by performing maintenance of the display apparatus 10 in accordance with the detection result of the abnormality.

(Appendix 2) The control method according to Appendix 1, wherein the obtaining the statistic further includes: obtaining, based on a second captured image acquired by capturing the inspection image projected onto the projection surface, a first statistic related to a plurality of chromaticities corresponding one-to-one to a plurality of points in the image at a first time point; and obtaining, based on a third captured image acquired by capturing the inspection image projected onto the projection surface, a second statistic related to a plurality of chromaticities corresponding one-to-one to a plurality of points in the image at a second time point subsequent to the first time point, and the control method further includes: determining whether a first change rate from the first statistic to the second statistic exceeds a second threshold value; and notifying the external apparatus of a second notification representing that the first change rate exceeds the second threshold value.

According to the configuration described above, based on the change rate of the color unevenness, it is possible to perform notification in which the occurrence of the abnormality is preliminarily predicted at an anterior stage of the actual occurrence of the abnormality. As a result, the user of the display apparatus 10 can perform necessary maintenance in the anterior stage of the actual occurrence of the abnormality.

(Appendix 3) The control method according to one of Appendices 1 and 2, further including: obtaining, based on a fourth captured image acquired by capturing the inspection image projected onto the projection surface, a third statistic related to a plurality of brightness values corresponding one-to-one to a plurality of points in the image at a third time point; obtaining, based on a fifth captured image acquired by capturing the inspection image projected onto the projection surface, a fourth statistic related to a plurality of brightness values corresponding one-to-one to a plurality of points in the image at a fourth time point subsequent to the third time point; determining whether a second change rate representing a rate of a change from the fourth statistic to the third statistic with respect to a period from the fourth time point to the third time point exceeds a third threshold value; and notifying the external apparatus of a third notification representing that the second change rate exceeds the third threshold value.

According to the configuration described above, the display apparatus 10 can detect the occurrence of an abnormality based on the change rate in brightness in the projection surface PF. In addition, it is also possible to detect an abnormality in brightness in the projection surface PF, which is difficult in the abnormality detection using an ordinary imaging device.

(Appendix 4) The control method according to Appendix 1, further including acquiring a sixth captured image by causing the imaging device to image the projection surface onto which the inspection image is not projected, wherein the plurality of chromaticities is chromaticities obtained by subtracting, from a plurality of chromaticities corresponding one-to-one to a plurality of first points in the image contained in the first captured image, a plurality of chromaticities corresponding one-to-one to a plurality of second points at same positions as the plurality of first points in the sixth captured image.

According to the configuration described above, it is possible to improve the accuracy of the statistic related to the plurality of chromaticities corresponding one-to-one to the plurality of points in the image CI corresponding to the inspection image CP.

What is claimed is:

1. A control method comprising:
causing, by one processor or a plurality of processors, a projector to project an inspection image onto a projection surface;
causing, by the one processor or the plurality of processors, a camera to capture the inspection image projected onto the projection surface to thereby acquire a first captured image including an image corresponding to the inspection image;
obtaining, by the one processor or the plurality of processors, a statistic related to a plurality of chromaticities corresponding one-to-one to a plurality of points in the image based on the first captured image;
determining, by the one processor or the plurality of processors, whether the statistic exceeds a first threshold value; and
notifying, by the one processor or the plurality of processors, an external apparatus of a first notification representing that the statistic exceeds the first threshold value.

2. The control method according to claim 1, wherein the obtaining the statistic further includes:
obtaining, based on a second captured image acquired by capturing the inspection image projected onto the projection surface, a first statistic related to a plurality of chromaticities corresponding one-to-one to a plurality of points in the image at a first time point; and
obtaining, based on a third captured image acquired by capturing the inspection image projected onto the projection surface, a second statistic related to a plurality of chromaticities corresponding one-to-one to a plurality of points in the image at a second time point subsequent to the first time point, and
the control method further comprises:
determining whether a first change rate from the first statistic to the second statistic exceeds a second threshold value; and
notifying the external apparatus of a second notification representing that the first change rate exceeds the second threshold value.

3. The control method according to claim 1, further comprising:
obtaining, based on a fourth captured image acquired by capturing the inspection image projected onto the projection surface, a third statistic related to a plurality of brightness values corresponding one-to-one to a plurality of points in the image at a third time point;
obtaining, based on a fifth captured image acquired by capturing the inspection image projected onto the projection surface, a fourth statistic related to a plurality of brightness values corresponding one-to-one to a plurality of points in the image at a fourth time point subsequent to the third time point;
determining whether a second change rate representing a rate of a change from the fourth statistic to the third statistic with respect to a period from the fourth time point to the third time point exceeds a third threshold value; and
notifying the external apparatus of a third notification representing that the second change rate exceeds the third threshold value.

4. The control method according to claim 1, further comprising
acquiring a sixth captured image by causing an imaging device to image the projection surface onto which the inspection image is not projected, wherein
the plurality of chromaticities is chromaticities obtained by subtracting, from a plurality of chromaticities corresponding one-to-one to a plurality of first points in the image contained in the first captured image, a plurality of chromaticities corresponding one-to-one to a plurality of second points at same positions as the plurality of first points in the sixth captured image.
